(19) United States
(12) Patent Application Publication
(10) Pub. No.: US 2005/0044099 A1
(43) Pub. Date: Feb. 24, 2005

(54) Process for creating an information services catalog

(76) Inventors: Thomas Soares, Santa Clara, CA (US); Boris Pevzner, San Francisco, CA (US); Ashwani Dhawan, Fremont, CA (US)

Correspondence Address: RONALD CRAIG FISH, A LAW CORPORATION, PO BOX 820, LOS GATOS, CA, 95032, US

(21) Appl. No.: 10/646,019

(22) Filed: Aug. 22, 2003

(51) Int. Cl. G06F 17/00

(52) U.S. Cl. 707/102; 707/100

(57) ABSTRACT

A process to assist an IT professional to interact with a computer to establish an IT services catalog by performing the following steps: (1) providing some computer displayed means by which the IT professional can choose between multiple processes including defining a new service, defining a relationship between a service and another service or IT resource, defining cost information or defining a service action which, when executed, can create, modify or destroy an instance of the service; (2) when the user chooses to define a new service, interacting with the user in any way to create a data structure which defines the service and which includes validation constraints and/or validation formulas; (3) when the user chooses to define a relationship, interacting with the user in any way to determine whether the relationship is to other IT services or to IT resources and to establish filter conditions within the selected class and to record appropriate pointers and filter conditions in the data structure which defines the service; (4) if the user chooses to define cost information, interacting with the user in any way allow the user to enter and store cost formulas in the data structure defining a service; and (5) if the user chooses to define a service action, interacting in any way with the user to solicit and store data which completes a data structure which defines the service action.

### FIELD OF USE AND BACKGROUND OF THE INVENTION

The biggest corporations today have information technology (IT) departments that are assigned to provide computing services for the company. IT services include everything a big company needs to run its business such as employee services, application services, application environment services, computing and storage services, networking and network security services, telecommunication services and facility services.

Employee services include: setting up new employees with work stations and software, moving employees to different organizations within a company, setting up email accounts, password resetting, printer setup, provision of telephony, FAX and voicemail services to the employee, providing access to application programs the employee needs to do his or her job, providing virtual private network access and desktop training.

Application services include: providing financial, ERP, and CRM applications, providing decision support, designing custom web applications, application configuration, output management, job scheduling, application support, application tuning, application upgrades and application training.

IT data center operations and application environment services include: providing production environment for package applications, providing production environments for custom applications, stage environments, and development environments and providing stress test environments.

Computing and storage services include: providing application program servers that users can log onto and run application programs on across the local area network, providing database servers, providing DASD and NAS storage, backing up data, providing clustered server configurations, providing internal servers, application monitoring, system monitoring and storage redundancy.

Network and security services include: providing WAN routers, providing campus routers and core switches, providing local area network (LAN) switches and firewalls, providing DNS servers and directory servers, providing intrusion detection, providing VLAN/RAS services, providing authentication services, providing ISP access and bandwidth to end users who need to transmit and receive data to and from outside and in-house servers.

Telecom services include: providing PBX, voicemail, voice-over-IP services, providing and setting up telephones, providing calling cards and audio and video conferencing services, and providing voice network carrier connections.

Facilities services include: office setup work, moving offices to different locations, data center setup, data center relocation, space management and physical disaster recovery.

IT services departments, like other departments in large companies, are under increasing pressure to be more efficient and to be accountable for being able to calculate and report the costs or setting up and/or providing all the above services. IT services can be contracted out to third party providers, and this reality makes IT professionals acutely aware that they must be efficient and accountable or suffer the consequences.

There are a host of problems that IT departments face in their quest to become efficient and accountable for costs of providing IT services. One of the problems that IT professionals face is the provision of an IT services catalog to end users which identifies all the things the IT department can do for an end user in the company to help that end user solve his or her problems. Another problem is providing a means whereby customers can order various IT services in a valid manner, i.e., in such a way that the order can actually be fulfilled. Another problem IT professionals face is, once an end user has placed an order for IT services, how can the IT department efficiently fulfill that order as measured by the speed, quality and cost of the work done to fulfil the order. Did they do what the customer asked them to do? Did they do it within the time constraints the end user established or at least within reasonable time limits? Did they do it efficiently, i.e., with as few people working on the problem as was necessary given the order and the time constraints? Another problem IT departments face is metering of services which means monitoring services providing and taking decisions on what assets are underutilized and can be shared. Another problem IT professionals face is how to gather statistics on such things as how long did it take them to turn a services on, what is the percentage of up time for the service, etc. These statistics are for reporting to management and monitoring purposes.

Both New Scale, Inc. and Computer Associates provide IT services catalogs implemented on computers, but neither has a unified data model. A unified data model is a data structure which contains data identifying all available IT resources, available IT people along with their roles and capabilities and business processes or recipes to bring IT services into existence and called workflows herein. Both New Scale, Inc. and Computer Associates provide a request based front end process to allow customers to come into the IT services department and interact with the IT services catalog system using language which is familiar to the customer (“customer speak”). New Scale does not provide a provisioning “engine”, i.e., a computerized process to take customer orders for IT services and implement a process to carry out the automated and manual steps in a workflow to provide the ordered service. Computer Associates does provide a provisioning engine, but it is not tied into a unified data model that defines the capital resources and IT professionals that are available. It therefore cannot provision combined IT services efficiently or possibly at all. Further, neither New Scale nor Computer Associates tools validate end user requests to make sure they can be fulfilled by the provisioning engine.

A provisioning engine is a computer process that receives a request for provision of an IT service and fulfills the request at the business process level by defining the overall process necessary to bring the service into existence and providing step by step instructions called a workflow to bring the service into existence. A provisioning engine may actually carry out any computer processing in the work flow to bring the service into existence and will detail any manual steps and the sequence of all the steps needed to bring the service into existence. A provisioning engine provides a workflow which is a recipe of what steps need to be taken and in what order to fulfill a service request. A provisioning engine also collects information from people who carry out the steps of a workflow regarding how much time it took to carry out each step. The workflow steps can be carried out in parallel or sequentially depending upon interdependency of steps.

There are two kinds of Workflow steps: manual and automatic. Workflow steps can be accomplished in three different ways by a provisioning engine: (1) by the provisioning engine generating work orders for people to carry out and monitoring the completion of each step and the cost and/or time to do each step for which a work order is generated; (2) the provisioning engine executes the automated step itself or communicates with another process running on the same or a different computer to execute the step. For example, automated steps may involve installing or configuring software.

Another problem that IT departments face is that end users speak in “customer speak” and often are not aware of what exactly IT departments can actually do or the correct terminology in the lexicon of IT professionals (“IT speak”) to tell the IT professional what the end user actually wants to order. As a result, orders are submitted in “customer speak” and must be translated to the “IT speak” terms that the provisioning engine can understand and act upon.

Accordingly, there is a need for a computerized process by which IT professionals can build an IT services catalogue and record constraints and validation rules in the data structure that represents the IT services catalog. There is also a need for a configuration process running on a computer which can receive end user orders for IT services in “customer speak”, validate those orders and convert them to a lower level IT speak which can be input to a provisioning process. Further, there is a need for a provisioning process which can execute on a computer and receive orders for IT services in IT speak and generate appropriate workflows to define the needed steps to bring the service into existence and gather statistics about costs to implement.

### BRIEF DESCRIPTION OF THE DRAWINGS

FIG. 1 is a diagram of a reference implementation of an IT services catalog.

FIG. 2 is a diagram showing how the invention is used. Requests for IT services are entered into the system by interfacing with the service catalog, as symbolized by arrow 38.

FIG. 3, comprised of FIGS. 3A through 3B, there is shown a flowchart of the process a computer implements to interact with an IT professional to define the services in an IT catalog.

FIG. 4 is a diagram of a typical implementation of the IT service catalog which results from using the process defined in FIG. 3 and showing the IT service attributes and the business attributes of the resulting IT services catalog.

FIG. 5 is a diagram showing how the process of FIG. 3 provides the editor tools necessary to provide the content of the IT services catalog and to modify the contents thereof and how the system catalog compiles workflows for a runtime database used by a fulfilment process.

FIG. 6 is a diagram showing how an IT solution configurator process 108 is used to receive requests from end users for new IT services or to change existing IT services and how the configurator interacts with the IT service catalog 99 and provides project/service fulfillment information, solution costs and delivery and quality metrics.

FIG. 7, comprised of FIGS. 7A and 7B, is a flowchart of the configuration process 108 to receive user inputs in “customer speak” defining what IT services they want, validate those requests using predefined validation rules in the IT services catalog and converting “customer speak” to “IT speak”.

### SUMMARY OF THE INVENTION

The genus of the invention is defined by any computer implemented process which can assist an IT professional to establish and IT services catalog by: (1) providing some computer displayed means by which the IT professional can choose between multiple processes including defining a new service, defining a relationship between a service and another service or IT resource, defining cost information or defining a service action which, when executed, can create, modify or destroy an instance of the service; (2) when the user chooses to define a new service, interacting with the user in any way to create a data structure which defines the service and which includes validation constraints and/or validation formulas; (3) when the user chooses to define a relationship, interacting with the user in any way to determine whether the relationship is to other IT services or to IT resources and to establish filter conditions within the selected class and to record appropriate pointers and filter conditions in the data structure which defines the service; (4) if the user chooses to define cost information, interacting with the user in any way allow the user to enter and store cost formulas in the data structure defining a service; and (5) if the user chooses to define a service action, interacting in any way with the user to solicit and store data which completes a data structure which defines the service action.

In the preferred embodiment, the process comprises the steps of:
(1) displaying a plurality of icons or menu choices which can be selected to start the process of defining a new service, establishing a relationship between a new service and a preexisting service and/or resource, define cost information or define a service action;
(2) if an icon or menu choice is selected to start the process of creating a new service, displaying one or more displays soliciting information from a user to name the service and define the fields and contents thereof for a data structure which defines an instance of said service and define attributes of each field including validation constraints and validation formulas, and receiving and storing any data entered by a user in response to said displays;
(3) if an icon or menu choice is selected to start the process of defining a relationship, displaying one or more displays soliciting information as to which preexisting service or IT resource to which the data structure of a service will point and receiving and storing any data entered by a user in response to said displays;
(4) if an icon or menu choice is selected indicating a user wishes to enter cost information, displaying one or more displays which solicit the user to enter information that define the name of a cost information formula and the cost information formula itself, and receiving and storing any data entered by a user in response to said displays; and
(5) if an icon or menu choice is selected indicating a user wishes to define a service action, displaying one or more displays that solicit the name of the service action to be defined and to define the fields and contents thereof for a data structure which defines an instance of said service action and attributes for each field, and receiving and storing any data entered by a user in response to said displays. In the preferred embodiment, the process implements each field in a data structure created when a new service is established is like a cell in a spreadsheet in the sense that the field can store text, numbers or a formula which, when evaluated by the computer, results in a value which is stored in the field. Each field in the data structure has attributes which are controlled by the user. The attributes are: whether or not the field is configurable (if configurable, its value can be changed by a user); whether or not the field may be overriden by the user (if a field can be overriden, its value acts as a default, but the value can be changed by the user); and constraints. Constraints are formulas that define maximum, or minimum limits for the values stored in a field or any formulas that define a property that must be true about a field.

### DETAILED DESCRIPTION OF THE PREFERRED AND ALTERNATIVE EMBODIMENTS

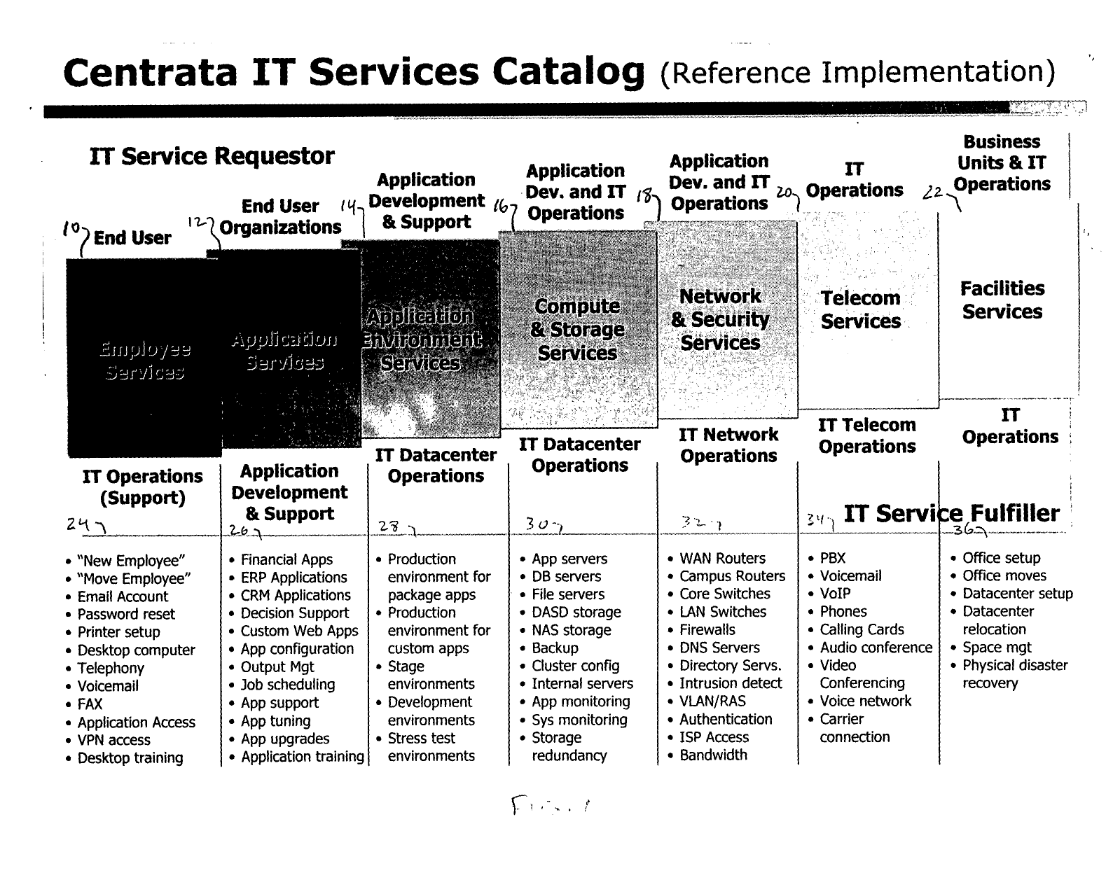

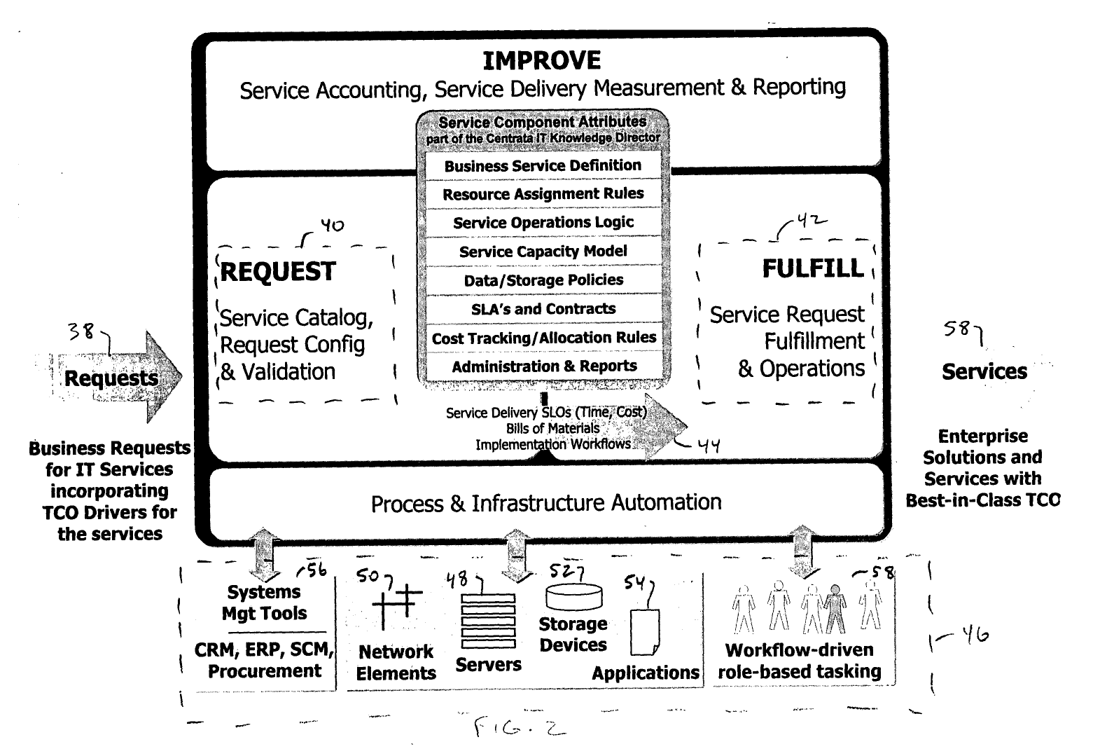

Referring to FIG. 1, there is shown a diagram of a reference implementation of an IT services catalog. The IT services catalog lists all the services an IT department can perform for end users in a company. In the case of an IT services third party provider, the IT services catalog lists all the IT services the provider can provide for its clients. The services are grouped into classes or silos which are: employee services 10; application services 12; application environment services 14; compute and storage services 16; network and security services 18; telecom services 20 and facilities services 22. The details of the types of services in each of these classes is listed below each silo at 24, 26, 28, 30, 32, 34 and 36. These individual services are identified above in the background section.

FIG. 2 is a diagram showing how the invention is used. Requests for IT services are entered into the system by interfacing with the service catalog, as symbolized by arrow 38. The users can enter their requests for IT services in terminology they understand, i.e., customer speak. Before this can happen, an IT professional builds an IT services catalogue using a process to be described more fully below. The request(s) for IT services are entered via a computer represented by arrow 38 which is logged onto an application server running an application that provides a user interface to the IT services catalog and which also runs the configuration process. The server or other computer running the process to provide the user interface to the service catalog and running the configuration process to validate the requests and convert them to IT speak is represented by dashed box 40. The request configuration process validates the request in accordance with rules encoded in the data structure which embodies the IT services catalog.

A server or other computer represented by dashed box 42 executes a fulfillment process. The fulfilment process accepts IT speak input from the configuration process 40 that defines the desired IT services and generates necessary documentation in the form of bills of materials, implementation workflows and service delivery time and cost estimates (SLOs) needed to bring the requested IT service into existence. These documents are represented by arrow 44.

The actual infrastructure on which these configuration and fulfillment processes (and the process controlled by an IT professional to generate an IT services catalog) run on an infrastructure represented by dashed block 46. This infrastructure is comprised of one or more servers 48 coupled directly or via network elements 50 to one or more storage devices 52. The network elements can be any local area network(s) (LAN) and/or any public or private wide area network (WAN). The servers 48 run application programs 54 and system management tools 56 such as Customer Relationship Management (CRM), Enterprise Resource Planning (ERP), or Supply Chain Management (SCM). The bill of materials and workflow documents are supplied to IT professionals 58 who use them to acquire the necessary computers, software, phones, PBXs, switches, routers, etc. to implement the requested service and carry out the steps detailed in the workflow.

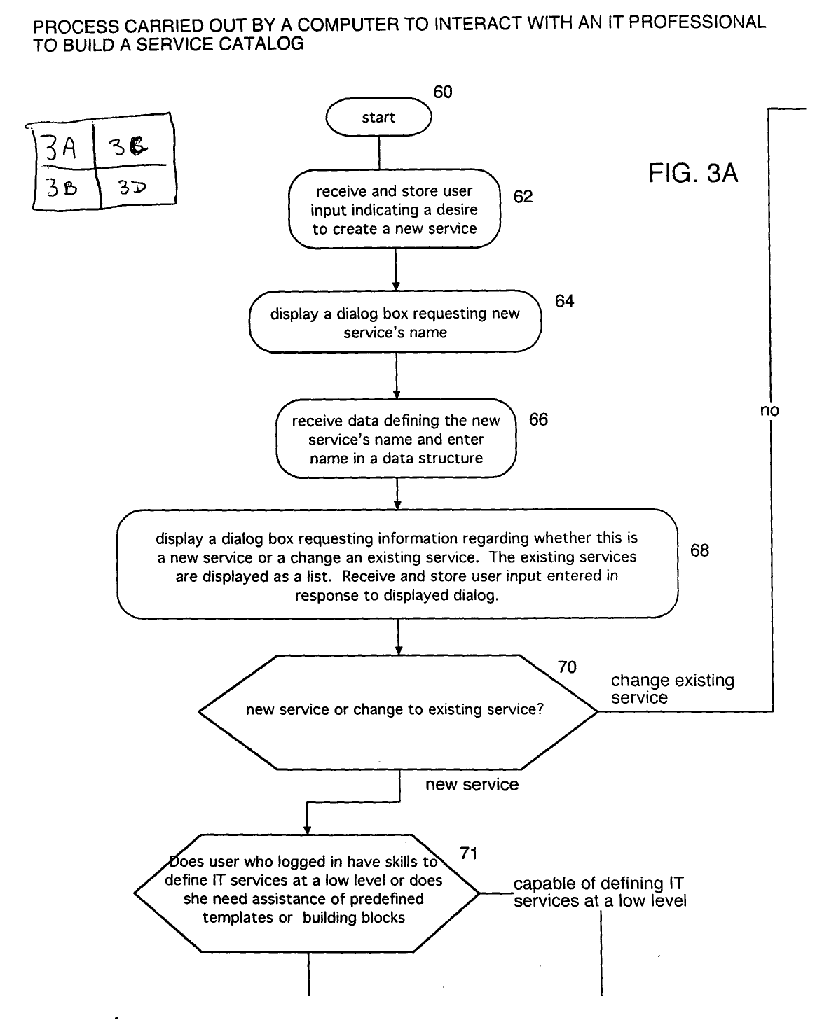

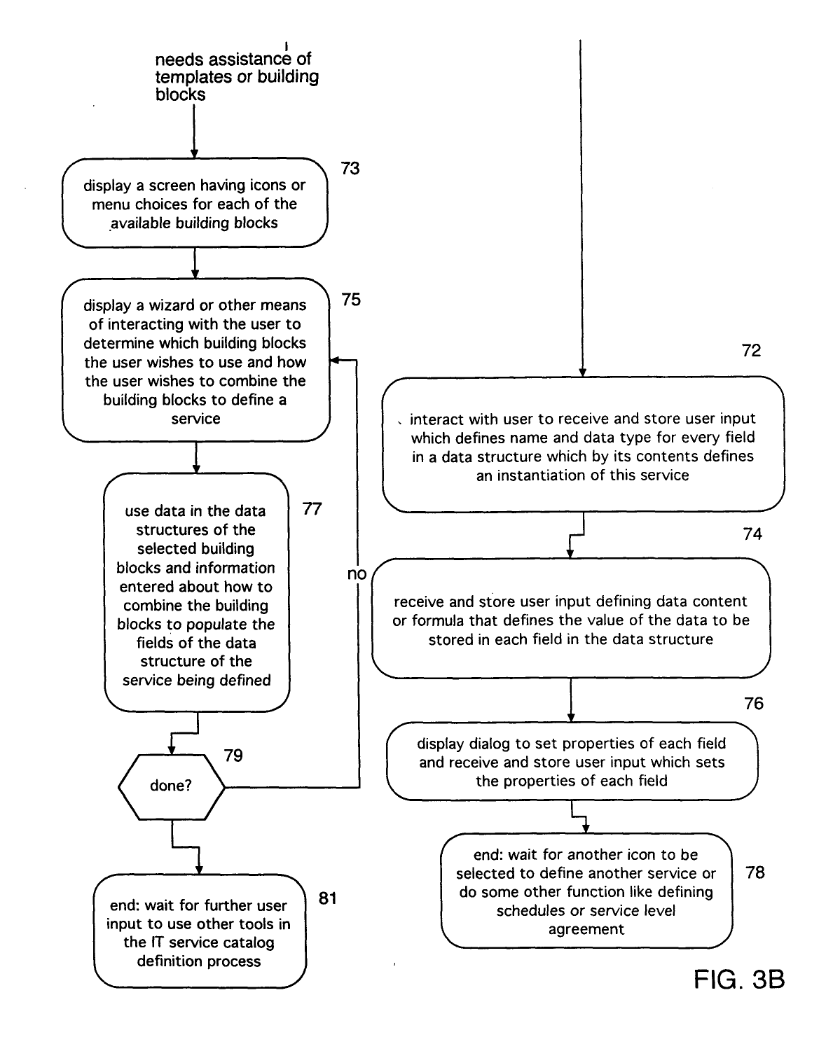

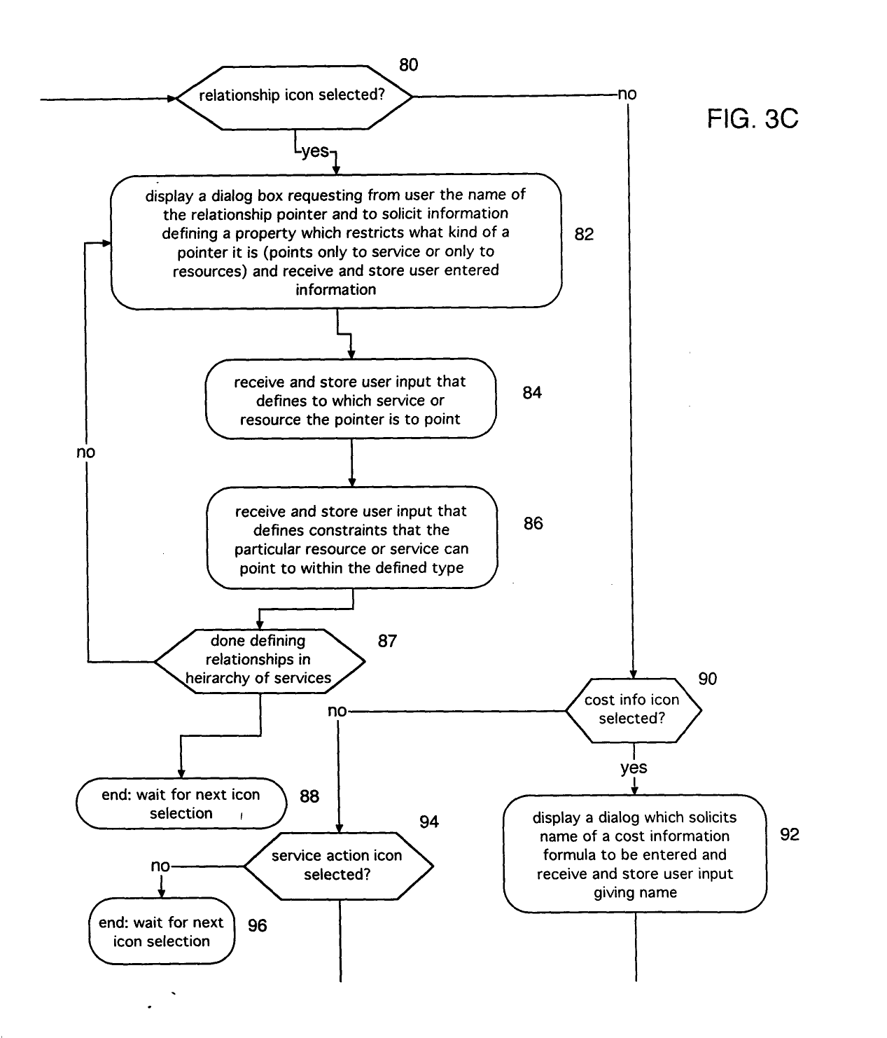

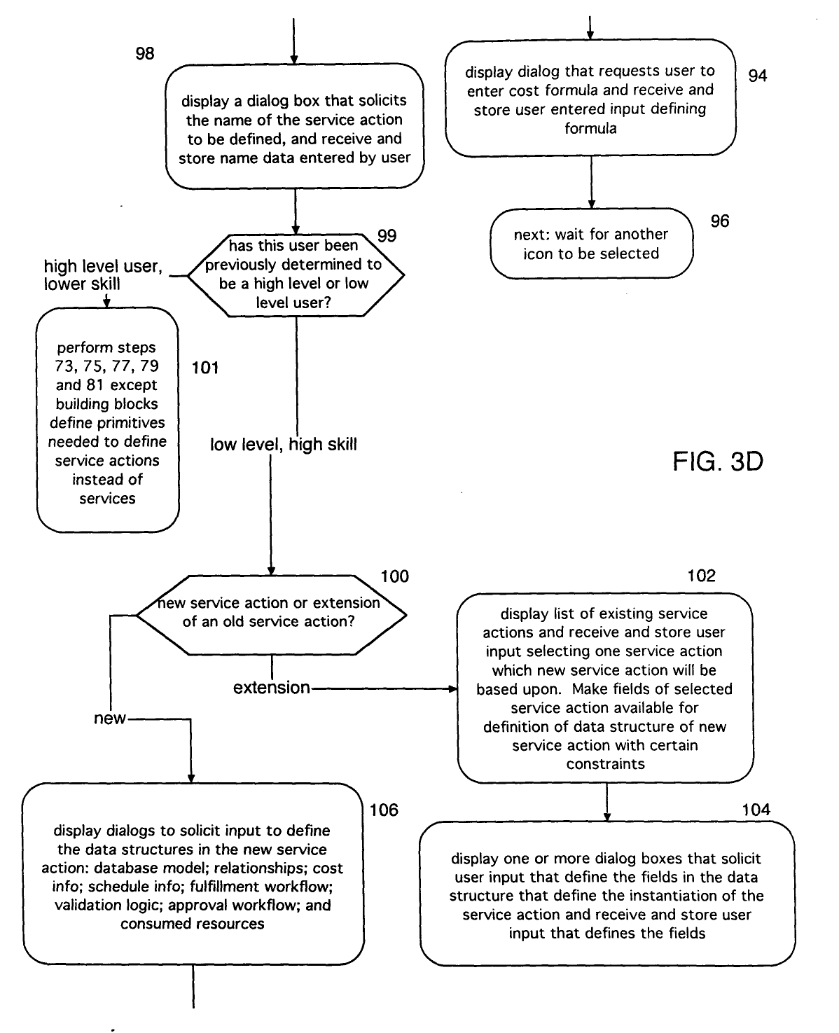

Referring to FIG. 3, comprised of FIGS. 3A through 3D, there is shown a flowchart of the process carried out by a computer to interact with an IT professional to build a service catalog. The process of building a service catalog requires that an IT professional (hereafter referred to as “she” when an indefinite pronoun is appropriate) interact with a computer to perform the following functions: she must create a new service definition for each new service she wishes to have in the IT services catalog: she must define a database model by defining what information is stored in the database for each instantiation of a service of a particular type; she must define the relationship of the new service to other services, i.e., how does the new service she is defining use the functionality of another preexisting service and what subservices does the new service use; she must record cost information by recording formulas that are used to compute the cost of implementing and/or using the service such as royalties, license fees, monthly recurring charges such as equipment rental; and she must define the service actions which are things one can do to create, destroy, use or change the service.

Each service action has its own structure. Specifically, each service action has: its own database model for that service action that contains data pertaining to the service action such as when to back up a drive, upon which type of media to back it up; relationships (pointers) to other services and/or resources the service action needs to use; cost information (formulas that define the cost to complete the service action one time); schedule information in the sense of an approximate time to complete the service action and how soon it can be started; fulfillment workflow which show how the service action can be created, changed and deleted; validation logic which shows how to verify the service action can be validated as correct; and approval workflows which are a recipe for a business process to get the new service approved within the organization.

The process starts at block 60 with a computer running the IT service catalog building process receiving a user ID and password of a login by an IT professional, and waiting for further user input. At step 62, an IT professional enters user input in any way indicating a desire to create a new service. The user interface can be any graphical user interface (GUI) to point and click on icons, radio buttons etc. to make selections and to type in data, or a command line interface can be used. Basically, any way a user can interact with the system to make choices and enter data will suffice to practice the invention. For shorthand purposes, when the system is soliciting information from the user and wants to interact therewith, the flowchart will use the terminology “display a dialog box”. This is to be understood and interacting with the user in any way to allow the user to make menu choices, enter data, select radio buttons, enter data or commands on a command line, etc. In step 64, the system solicits the user to enter data defining the name of the new service. This can be done by displaying a dialog box or in any other way. In step 66, the computer receives user input in the form of data defining the new service's name. This data is entered in a data structure.

Step 68 represents the process of determining whether this is a request to establish a new service or to change an existing service. This is typically done by displaying a dialog box which asks the question whether this is a new service or a change to a preexisting service.

Test 70 causes branching to the appropriate steps based upon whether the request was to establish a new service or change an existing service. If a new service has been requested, this means that a completely new data structure is to be created which defines an instantiation of this new service. Processing then proceeds to test 71 which determines from the user password and user name if the user who logged is has the skills to define IT services at a low level. If so, then processing proceeds to step 72 and following to be described below. If the user is one who needs the assistance of templates and stencils, then processing proceeds to step 73. It is possible in the preferred embodiment to define IT services, service actions, relationships between services or between service actions using predefined primitives which are also referred to herein as stencils or templates. These predefined templates are aggregations of lower level services, service action, approval workflow tasks and fulfillment workflow tasks which have been previously defined by an IT professional with a higher level of skill and which are commonly used in definitions of services, service action and relationships. These templates can be used to save great amounts of time in defining IT services since they are building blocks like lego that a user may use to rapidly construct more complex services, service actions or relatioships therebetween without being bothered by the myriad of details of defining the data structures of the building blocks themselves.

The building blocks include organizational standards on the types of resources each service can use. For example, it might be that an organization has decided that all email servers will be Dell servers. These types of standards are built into the building blocks when they are defined so that any service built from an aggregation of building blocks will automatically conform to the organization standards as to which types of resources to use.

Step 73 represents the process of displaying in any way (icons, menu choices etc.) the available building blocks which the user can use and aggregate to define a service. These icons or menu choices are the palette available to the user.

Next, in step 75, the computer displays a wizard or any other means of interacting with the user to receive input from the user that determines which building blocks the user wishes to use to define a service and how the user wishes to combine those building blocks. When the user enters information that defines which building blocks she wants to use and how she wants to combine them, that information is recorded, and the data in the data structures of the selected building blocks is used to populate the fields of the data structure defining the IT service which the user is attempting to define, as represented by step 77.

Test 79 determines if the user is done aggregating building blocks and defining relationships between them. If so, processing proceeds to step 81 where the process of defining a new service ends, and the computer waits for further input to use other tools in the IT service catalog definition process. If the user is not done, processing returns to step 75 for selection of further building blocks and aggregations thereof followed by step 77 to build the data structure of the IT service being defined.

If the icon indicating a completely new service is to be defined is selected, step 72 is performed. In step 72, the system interacts with the user in any way to receive user input which defines the name and data type for every field in a data structure which by its contents defines an instantiation of the new service. Step 72 can be reached either if the service being defined is entirely new or if the new service is a changed version of the old service. If the service being defined is a modified version of an old service, all the fields of the old service will be displayed or will be available for display in the data structure being built but the user will be restricted. The user will not be allowed to remove the old fields and can only add new fields. The user will be allowed to change the attributes of the fields from the preexisting service except for the name and the data type. For example, the workflow field contents can be modified or replaced altogether, the attributes of any field can be changed including the validation constraints and the validation formulas may be changed. The formulas in any field of the preexisting service data structure can be changed.

The fields that need to be defined are: a database model; relationships; cost information and service actions.

The database model is a description of the information that needs to be stored in the data structure to define an instance of the service.

The relationships are pointers to other services or resources that the new service may be based upon or of which the new service is an extension. Each service can have multiple relationship pointer fields. How many any particular service has is defined by the IT professional at design time while the process of FIG. 3 is being executed.

The cost information are formulas or constants that define how to compute the cost to implement and/or use the service.

The service actions are operations such as create, modify or destroy that can be performed when using the service. The fields in the data structure of a service relating to service actions contain pointers to specific service action data structures for service action which can be invoked to create and instance of the service, modify an instance of the service or delete an instance of the service or do some other action relating to the service.

At design time, services and their corresponding service actions are defined. At fulfillment time, a service action associated with a particular service is invoked and executes to output a Request for Service (RFS). An RFS contains a bill of materials needed to implement an instance of the service, a fulfillment workflow of the steps needed to bring an instance of the service into existence and the order, if any, that the steps need to be performed, and estimates of the cost to implement the service and the estimated schedule to completion of implementation of the service instance. These documents are used by IT professionals to bring an instance of the service into existence.

Each service action has its own data structure which includes both fulfillment and approval workflows to carry out the service action and get it approved by managment, respectively. A workflow is a recipe of the steps that need to be performed and the order in which the steps need to be performed to carry out the service action's function. The service action data structure is defined more fully below.

Step 74 represents the process of the user entering formulas in any fields of the new service that have as the value stored in the field the results of the formula. The data structure and the process of defining new services are modelled after a spreadsheet in that every field is the same as a cell in a spreadsheet. That is, each field in the data structure can store text, numbers or formulas. The formulas are not visible in the field, and only the results of evaluating the formula are displayed in the field. The formulas can use as variables therein any defined field in the data structure of this service or another service even if the defined field is part of the data structure that defines an instantiation of another service which has no relationship to the service being defined. The data structure that defines a service includes: a database model (data model) that defines what data is stored in a database or data structure which defines the service; relationships or pointers to other services and/or resources so that the functionality of other services can be used to define the functionality of the new service; cost information which are constants or formulas which define the cost of creating and/or using the service; and the service actions which are operations that a user can do when a service is used such as “create”, “destroy”, “change”, etc. Each service action has its own data structure which includes: a database model for the service action; relationships to other service action and/or resources to be used in defining the service action; cost information; schedule information on the time to complete the service action and how soon it can be started; a fulfillment workflow (the IT professional defines the steps in the workflow needed to carry out the service action when the service action is created such as how does one create the associated service, how does one change the associated service and how does one delete the associated service); validation logic in the form of formulas to validate that all constraints on the contents of the fields of the service action data structure have been properly respected; and an approval workflow which are the steps the IT professional defines as to how to get the service action approved for implementation, i.e., how to get management to approve the expense of implementing the service.

Step 76 symbolizes the process of setting the properties of each field in the data structure. Each field in the data structure has the following properties which are associated with the field: configurable; overrideable; and constraints. Each property is either a true or false value. A true value stored in the configurable property field means the user can change the value of the field having this property. A false value for the configurable property means the value of the field must be changed programmatically (by rewriting the program) which means it is essentially a constant. A true value in the overrideable property means the value stored in the field having this property is a default value which can be changed. A false value for the overrideable property means the formula is fixed and whatever value the formula stored in that field generates is fixed and cannot be changed by the user. Constraints are used for validation of requests for a service. Constraints are formulas that define maximum, minimum limits for the field or any formula that defines a property that must be true about the field. For example, a formula can be entered which defines for validation of a field, the content of the field must be less than 1500. After defining the fields names and data types and defining the values or formulas in each field and the properties of each field, the definition of the new service is complete.

Step 78 represents the process of the system waiting for the user to select a new icon or otherwise indicate the user wants to define a new service or perform some other function.

Returning to the consideration of step 70, if the user did not indicate that a new service was to be defined, processing proceeds to step 80 which is a test to determine if the user has indicated that the service is to have a relationship with a pre-existing service. Most IT services catalogs have services which are arranged a heirarchy. There is usually a core services catalog which is predefined and does not to be defined by the IT professional at design time. The core services are IT services which everybody frequently uses. They are like templates or predefined macros in a word processor and function as building blocks which can be “consumed”, i.e. performed as part of a higher order service in the heirarchy. The service actions to be described below which are executed to create, modify and destroy instances of services also are arranged in heirarchies which are established by pointers in the data structures of the service actions. The same is true for resources: they are arranged in a heirarchy defined by pointers in the data structures of the resources. The data structures of the resources define the attributes thereof.

A relationship takes the form of a pointer in the data structure of a first service to the data structure of a second service with which the first service is to have a relationship. To consume a lower order service such as one of these core services, it is only necessary to define a pointer in the data structure of the service being defined by the IT professional at design time which points to the core service or some other preexisting service that the IT professional has previously defined during design time. These pointers which are established in the data structure of each service define the heirarchy and the place of each service in the heirarchy.

The significance of the pointers is that at run time, when a service is to be created, the pointers in the data structures of the service heirarchy can be used to generate the bill of materials. This is because the data structure of each service in the heirarchy contains data which defines the type and amount of resources that will be consumed by the service. By traversing these pointers in the heirarchy of service data structures, a bill of materials can be created at fulfillment time which defines all the resources that will be consumed by every service in the heirarchy. The significance of the pointers in the data structures of the service action heirarchy is that they define all the service actions that need to be executed to create, modify or delete a service. In the case of creation, each service action in the heirarchy will have a fulfillment workflow that has been defined by the IT professional at design time which gives the steps which need to be performed. The heirarchy of fulfillment workflows defined by the pointers in the service action data structure heirarchy can be traversed to generate a fulfillment workflow that includes all the steps of all the fulfillment workflows in all the service actions in the heirarchy.

If the user indicates that he wishes to define a relationship between the new service and another preexisting service (such as one of the core IT services) or a resource, processing proceeds to step 82. There, the system diplays a dialog box requesting from the user the name of the relationship pointer to be defined and to solicit information defining a property which restricts what kind of a pointer is to be defined to implement the relationship. Pointers can take two forms: a pointer to another service; or, a pointer to a resource. The property restricts what type of pointer is to be defined and causes the system to retrieve only a list of other services to which the pointer can point or only a list of other resources to which the pointer can point depending upon the value entered for the property.

Next, in step 84, the system receives user input that defines to which service or resource the relationship pointer is to point so as to establish one level in the services heirarchy. The pointer can be defined as a formula that defines a default value of which service or resource to which to point. The user can also leave the pointer blank and not fill it in, in which case the fulfillment process will fill it in for the user at the time of fulfillment processing.

Next, step 86 is performed where user input is received which defines the constraints that the particular resource or service can point to within a defined type. These additional constraints are filters on the particular members of the class defined by the constraints entered in step 82 which are eligible to be pointed to by the pointer. In other words, if the class constraint defined in step 80 is IT resource “computers”, the constraint entered in step 86 may be to restrict the pointer to only point to computers with more than 80 gigabytes of disk storage. These constraints can be used to enforce enterprise standards of preferred vendors for particular types of equipment or preferred models of equipment from a particular vendor. Thus, the service can be defined as requiring, for example, that an email server be a Dell server, model 2500.

After performing step 86, processing proceeds to test 87 which inquires whether the IT professional is done defining relationships in the heirarchy of services. If not, processing proceeds back to step 82. If so, processing proceeds to step 88.

Returning to consideration of step 80, if the user does not select a relationship icon, processing proceeds to test 90 where it is determined if the user selected a cost information icon indicating the user is now ready to define cost information for a service. If the cost information icon has been selected, processing proceeds to step 92 where the system displays a dialog box which solicits the name of a cost information formula to be entered. The name of the cost information formula entered by the user is received and stored.

Next, step 94 is performed to display a dialog that request the user to enter a cost formula and receive and store user input that defines the cost formula. The formula can have as its variables any defined field in any data structure defining an instance of any service. Step 96 ends the cost formula entry process and waits for selection of another icon.

Returning to step 90, if the cost info icon was not selected, test 94 is performed to determine if the service action icon was selected. If not, step 96 is performed to end the process and wait for another icon selection. Depending upon the icon selected, the processes starting with step 62 or step 82 or step 92 or step 98 are repeated.

If the service action icon was selected, it means that the user wants to define a data structure which defines an instantiation of a service action. Recall that defining service actions that create, destroy or change IT services is part of the process of defining an IT service in the service catalog. Each service action has its own data structure which includes a database model, relationships to other services or resources, cost information, schedule information, a fulfillment workflow, validation logic and an approval workflow. To start the process of defining this data structure, step 98 is performed to display a dialog box which solicits the name of the service action to be defined and to receive and store in the data structure of the service action any user input of the name of the service action to be defined.

Service actions can also be defined using building blocks or primitives in the same way previously discussed for defining IT services. Accordingly, test 99 is performed after step 98 to determine if this user has been previously determined to be a high level or low level user. If the user's user name and password indicates she is a low level user, processing proceeds to test 100. If the user is a high level user who needs the assistance of building blocks, processing proceeds to step 101. Step 101 represents the process of performing like steps 73, 75, 77, 79 and 81 previously described except that the palette of building blocks will be primitives which are frequently used in defining service actions instead of services. These building blocks can be lower level service actions, steps in approval workflows or steps in fulfillment workflows. The user selects the building blocks she wants to combine and how she wants to combine them and the data in the data structures of the selected building blocks is used by the computer to populate the data structure fields of the service action being defined.

Next, test 100 is performed to determine if the service action to be defined is new or an extension of a previous service action. If the user indicates that the service action is an extension of an existing service action, step 102 is performed. There, the system displays a list of existing service actions and displays one or more dialog boxes soliciting user input that defines which service action will be the basis of the new service action to be defined. The user input is recorded, and the fields of the data structure of the preexisting service action selected by the user are made available for definition of the data structure of the new service action. However there are constraints on changing the old fields. Specifically, in defining the new service action, the name and data type of fields of the preexisting service action cannot be changed. However, other changes to the fields of the preexisting service action data structure (only a copy of it is included in the data structure of the new service action so the changes do not change the fields of the data structure of the preexisting service action) can be made such as in the formulas or workflows or properties such as validation constraints on any particular field. This methodology to define a service action based upon the data structure of a preexisting service action is the same as the methodology to create a new service based upon or as an extension of the data structure of a preexisting service.

Next, step 104 is performed to display one or more dialog boxes that solicit user input that define the fields in the data structure that defines an instance of the service action. Specifically, dialog boxes are displayed which solicit user input to define: what fields to add to the data structure; relationships to other service actions and/or resources the new service action will have; cost information formulas that define the cost to implement and/or use the new service action; schedule information defining how long the service action takes to complete and when it can be started; workflow steps (the IT professional defining the service action defines the workflow steps needed to accomplish the service action such as how to create, modify and/or destroy the associated service); formulas that define validation logic to ensure that any constraints on the values in fields of the data structure of the service action are respected and the values in the fields are valid; and an approval workflow which comprises the IT professional's recipe of steps needed to get management approval to carry out the service action. Existing formulas, constraints and other properties of the fields of the copy of the preexisting service action's data structure can be changed. Also, the preexisting fulfillment and approval workflows can be modified or replaced (the field itself stays, but the content can be modified or entirely replaced). Again, workflows are recipes that defines the steps that need to be performed and the order in which they need to be performed to accomplish the service action.

In the preferred embodiment, the workflow recipes for both services and service action are created by drawing a picture of the desired workflow. This is done using icons selected from a palette of workflow icons and connectors selected from the palette to connect the icons.

If the user indicates that a new service action not based upon a preexisting service action is to be created, test 100 vectors processing to step 106. There, the system displays one or more dialog boxes to solicit user input that defines the fields in the data structure which defines an instantiation of the new service action. The fields in a data structure defining a new service action are: database model; relationships; cost info; schedule info; fulfillment workflow; validation logic; and approval workflow; and consumed resources. The IT professional writes the steps of the approval workflow so as to implement the particular approval and acquistition policies of the company or other entity for which he works. The IT professional fills in pointers in the data structure of each service action so as to implement a heirarchy of service actions such that the proper tasks needed to implement an instantiation of an IT service are performed (according to the fulfillment workflows of one or more service actions to create an instance of the service). The IT professional then writes the steps of the fulfillment workflow of each service action in the heirarchy so as to perform each step in the sequence of steps needed and so as to route any steps that need to be accomplished by a person to a particular IT professional or an IT professional with the appropriate skills. The same is true for approval workflows. Any manual steps are specified in the approval workflows to be accomplished by an IT professional with the appropriate skills.

While writing the steps of the fulfillment workflow, the IT professional defines the types and how much of the physical and logical resources in inventory will be consumed by each step. This information is used to create the bill of materials.

The semantics and content of these fields in the data structures of service actions are as previously described. The dialog box that solicits validation logic user input solicits the user to enter data that defines the constraints on each field in the data structure such that they can be validated. The dialog that solicits schedule information solicits user input (often in the form of formulas) that defines the estimated time to establish a service (duration of the setup time) and the estimated start time. The workflows for fulfillment and approval is drawn using the workflow palette of icons and connectors in the preferred embodiment.

After completion of step 106, or completion of the IT service catalog, it is time to decide whether to create a service advisor in the form of a decision tree which will help the user who does not understand IT speak to specify the desired IT service. The user can specify whether to create a service advisor by launching a tool to create service advisors, and this process is represented by step 107 in FIG. 3E. If the user chooses to not create a service advisor, the process ends as symbolized by step 109.

If the user chooses to create a service advisor, a loop is entered where the user specifies a series of questions in three or more categories and specifies branching conditions based upon anticipated answers and specifies recommended IT services so as to define the decision tree discussed elsewhere herein. The basic categories of questions that must be defined are: size (how many users the requested IT service must support); cost; service level agreement (how reliable does the IT service requested need to be in terms of up time or response time to the user). After each question is defined by entering the question in a dialog box or by any means of interacting with the computer, the user is asked whether he wants to define another question. During the process of defining the questions, the IT professional also specifies other questions to branch to based upon various scenarios of anticipated user answers or specifies particular recommendations of an IT service or collection of IT services appropriate to the user's original request based upon the user's possible answers to the question. The series of questions and branching conditions based upon anticipated answers essentially records the knowledge of the IT professional in what types of IT services are available and how they should be specified. The questions defined are such that the answers can be used to populate the fields of the data structure(s) of the service actions in the IT services catalog. When the IT services catalog is defined by the process of FIGS. 3A-3D, all that is created is a series of data structures with fields which have defined semantics and with pointers to various workflows and to establish service action heirarchies, but the fields are empty (except for fields that have pointers). The contents of these fields in the IT services catalog are what define the type of a service and how to create, modify and delete an instance of the service by associated service actions. The advisor tool represented by FIG. 3E is a tool which is used to define wizards that are used at configuration time to help fill in the fields of the data structures in the IT services catalog to specify the desired IT service properly in IT speak.

If IT professional does not have any more questions, the process ends, as symbolized by line 111. The process of defining this first series of questions is represented by block 113.

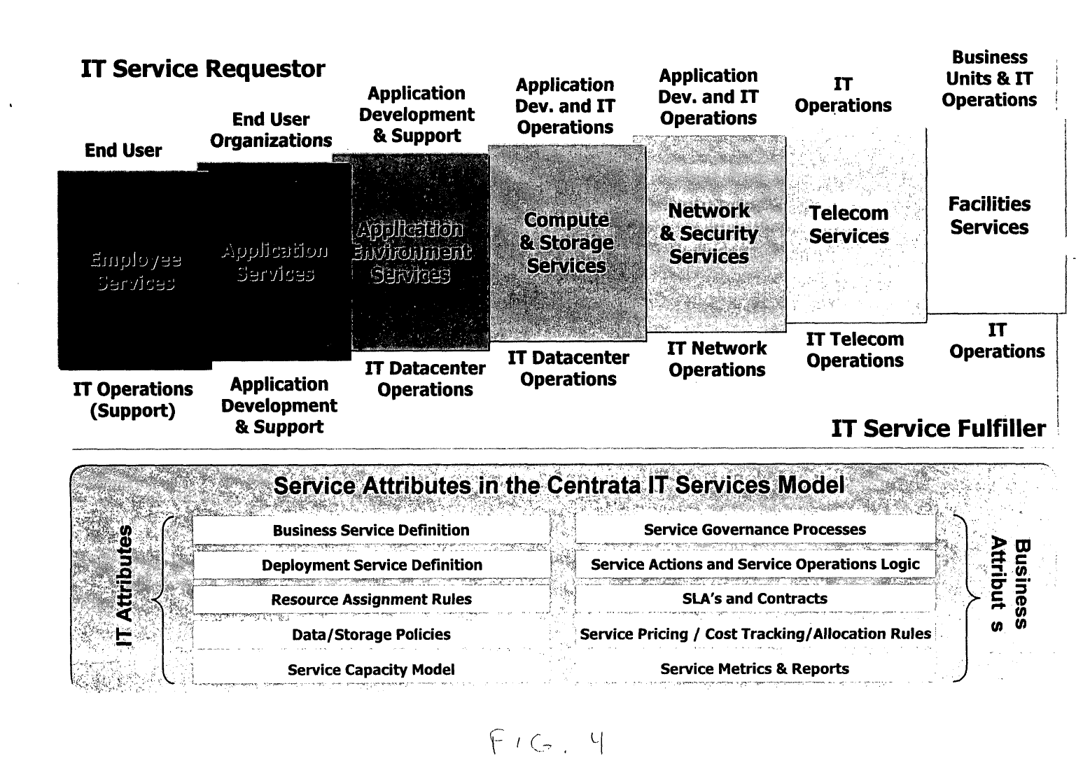

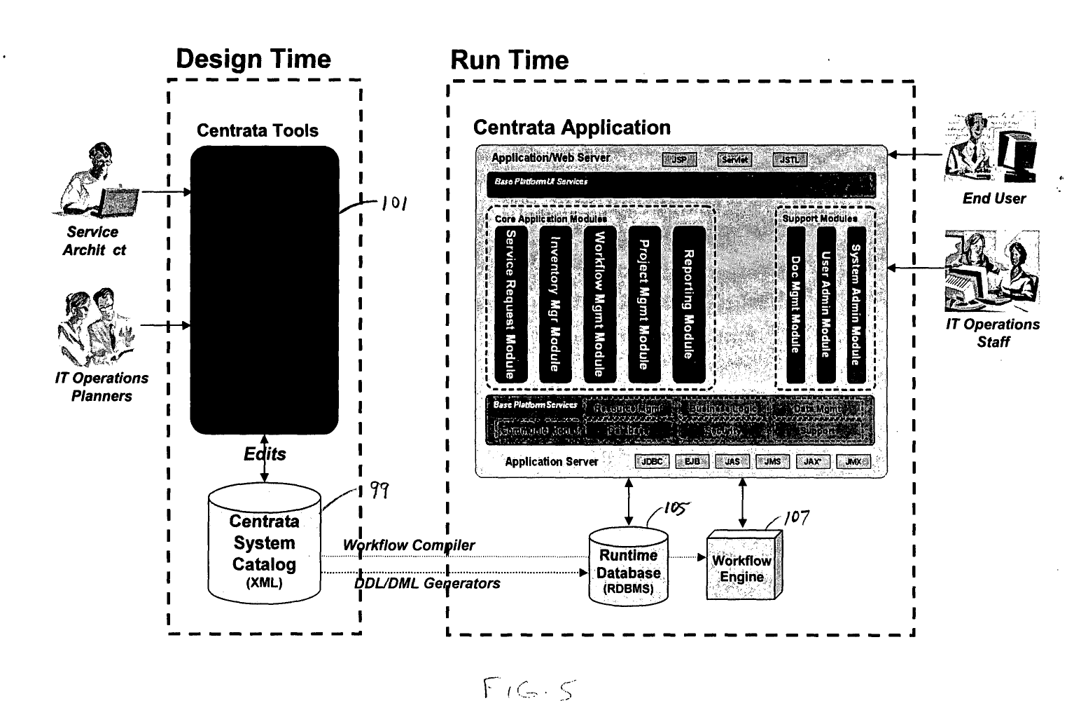

FIG. 4 is a diagram of a typical implementation of the IT service catalog which results from using the process defined in FIG. 3 and showing the IT service attributes and the business attributes of the resulting IT services catalog. The IT attributes are: business service definitions; deployment service definitions; resource assignment rules; data/storage policies and service capacity models. IT attributes are lower level attributes which are specific to a service and relate to how do you create a service, what does it consume, how do you configure the service. The resource assignment rules are designations by the IT professionals which indicate what types and quantities of physical or logical IT resources are available in inventory, and how much of each would be required to fulfill a particular IT service request. For example, when an IT service “create a server” is defined, one must define what kind of a server it is, how much memory and disk storage it has, CPU type, etc. These attributes are defined as part of the process of defining the service, and are recorded in the data structure which defines the service. The business attributes of the IT services catalog are: service governance processes; service actions and service operations logic; SLA's and contracts, service pricing/cost tracking/allocation rules; and service metrics and reports. Business attributes are the attributes of the service that are relevant to business executives who are not IT professionals. Business atttributes are recorded in the fields of the IT services catalog when the service is defined by an IT professional.

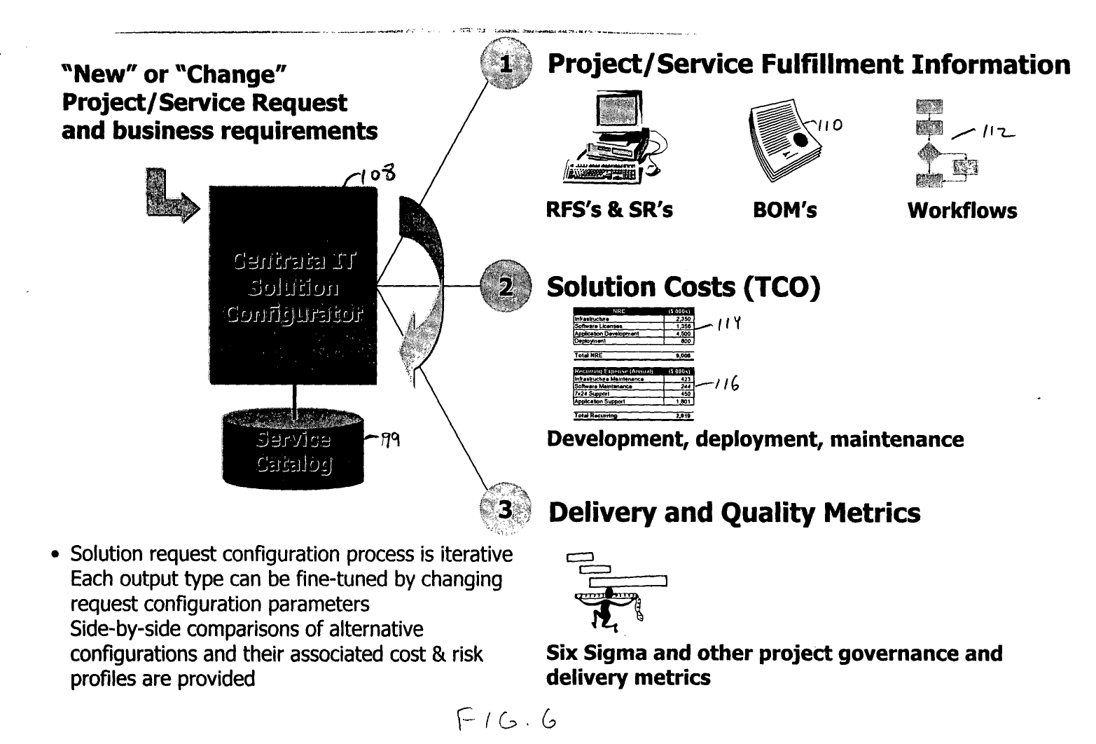

FIG. 5 is a diagram showing how the process of FIG. 3 provides the editor tools 101 necessary to provide the content of the IT services catalog 99 in XML. The editor tools also can modify the contents of the IT services catalog. FIG. 5 also shows that the system catalog compiles workflows which are store in a runtime database 105 which is used by a fulfilment process executed by a workflow engine 107 to create the requested IT services.

FIG. 6 is a diagram showing how an IT solution configurator process 108 is used to receive requests from end users for new IT services or to change existing IT services and how the configurator interacts with the IT service catalog 99 and provides project/service fulfillment information, solution costs and delivery and quality metrics. The fulfillment information is a heirarchy of Requests For Services (RFS). RFSs are forms output by the configuration process to specify which services are to be implemented and how. Each RFS typically includes a bill of materials 1 10, workflows 112 and estimated costs and estimated completion schedule. The bill of materials is written based upon the statements made in the fulfillment workflows where the resources needed to accomplish each step are reserved by the IT professional who knows what resources will be consumed by each step. The heirarchy of RFSs are for the whole job and any sub-jobs that need to be performed. The solution costs are divided into non recurring costs 114 and recurring costs 116 for development, deployment and maintenance of the requested IT services. The delivery and quality metrics are six sigma and other project governance and delivery metrics.

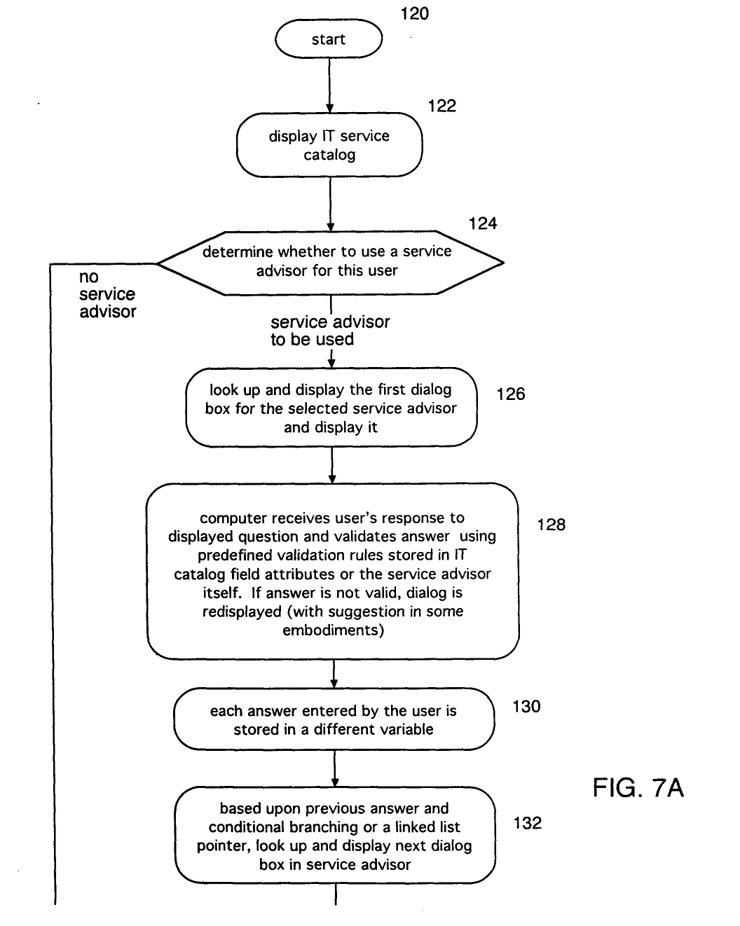

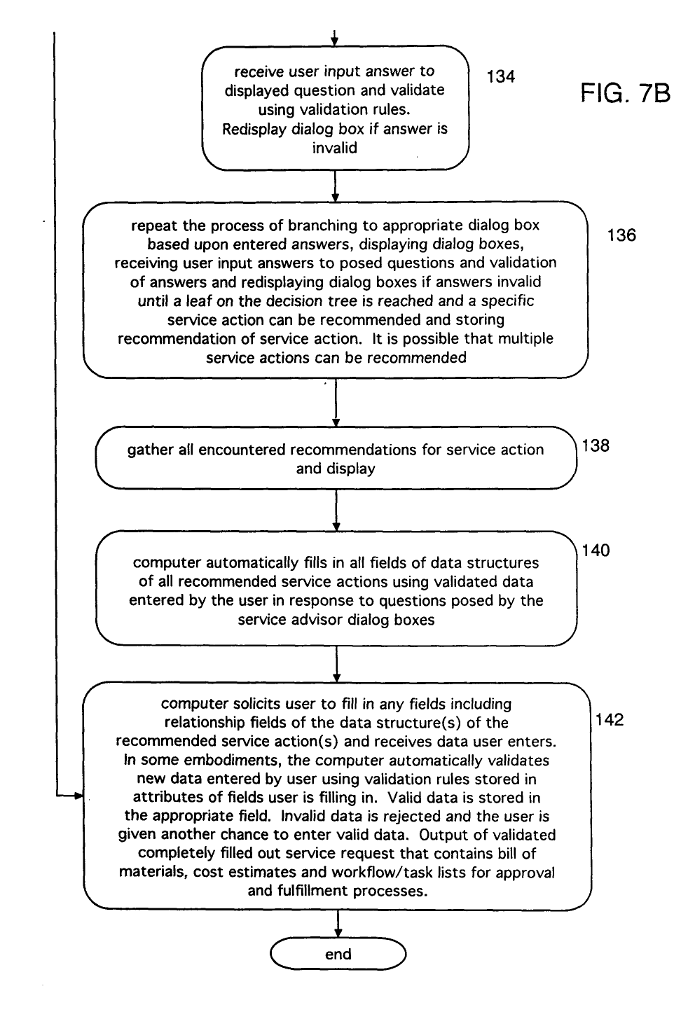

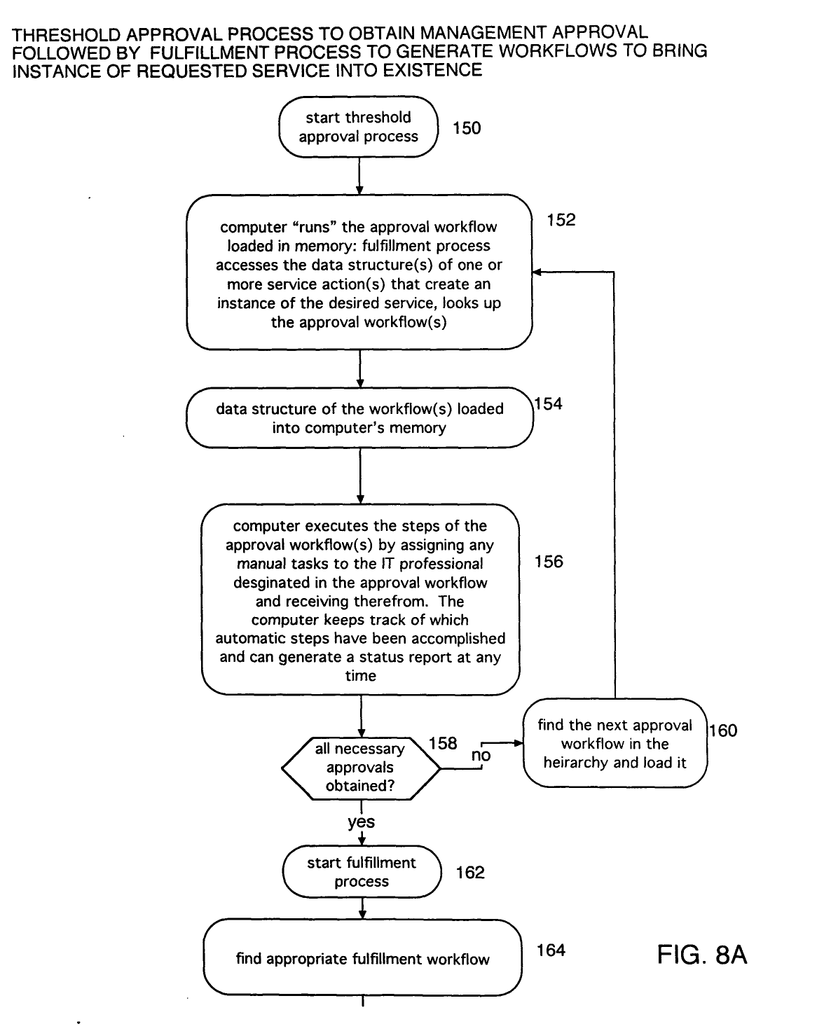

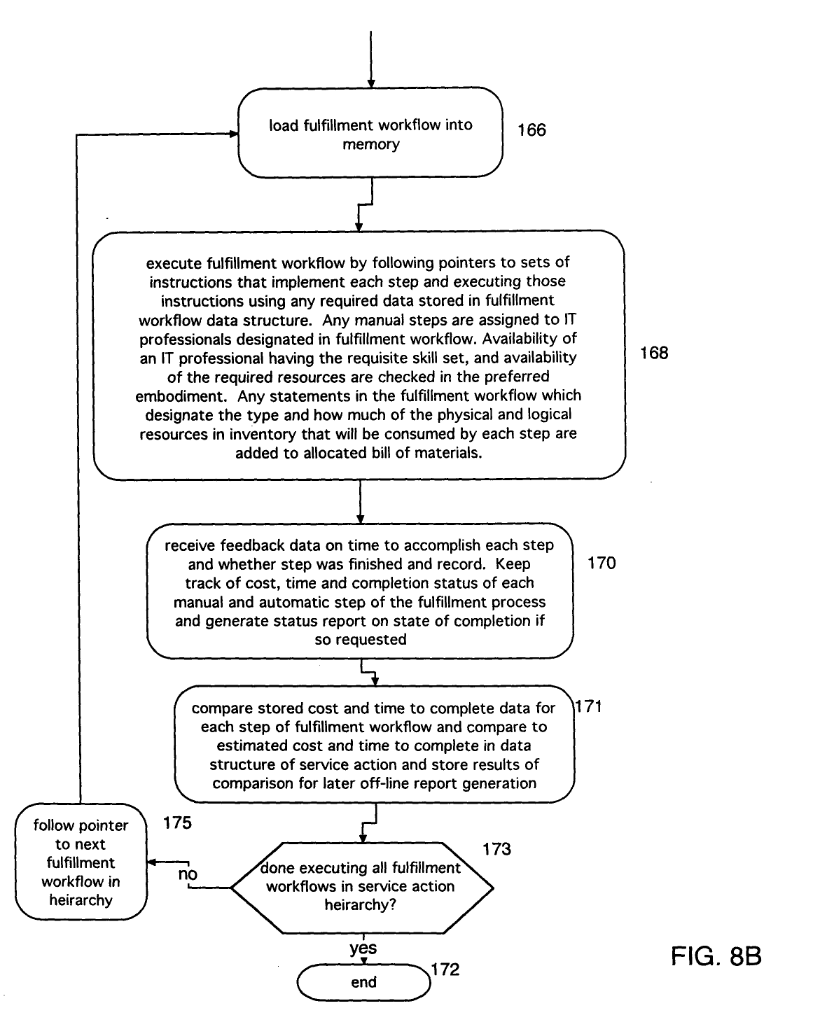

Referring to FIG. 7, comprised of FIGS. 7A and 7B, there is shown a flowchart of the configuration process 108 to receive user inputs in “customer speak” defining what IT services they want, validate those requests using predefined validation rules in the IT services catalog and converting “customer speak” to “IT speak”. The process starts at block 120 and then proceeds to step 122 to display the IT services catalog built with the process of FIG. 3. Step 122 also displays a list of service advisors (which are like wizards in the Windows® and MAC OS® operating systems) and are designed to assist a customer who does not know the correct IT terminology for the service the user wants to select the correct service action. The service advisors displayed in the IT services catalogue have been predefined as decision trees by an IT professional during the process of creating the IT service catalog. Each leaf on the decision tree is a specific service action recommendation. Each decision tree is a preprogrammed question with branching to other questions based upon the answers given by the user until a leaf on the tree is reached and a specific service action recommendation can be made.

In step 124, the system determines whether this user knows the appropriate service action to select to create an instance of the service the IT professional is requesting. In an alternative embodiment, this determination is made by determining whether the user selected a particular service action from the displayed list or whether the user picked a service advisor. If she picked a service advisor, it is assumed that the user does not know the proper IT terminology for the service she wants, so processing branches to step 126. In the preferred embodiment, the system determines whether or not to use a service advisor based upon knowledge of the user's skill set from the user name and password used to log in. If the user is known to not have a sufficiently high level of skill to pick the correct service action(s) and fill in the service action data structures, the system will automatically branch to step 126 to start the wizard process of traversing the decision tree to help the user pick the right service action(s) and fill in the data in the data structures thereof using validated responses to questions asked during the process of traversing the decision tree. If the user's log in indicates the user has a high level of skill, the system will automatically transition to step 142.

In step 126, the first dialog box for the selected service advisor is looked up and displayed. Step 128 is then performed to receive the user's response(s) to the displayed question(s) and validate the answers. The answers are validated using the maximum and/or minimum constraints and/or validation formulas stored by the IT professional in the IT services catalog or in the service advisor itself in some embodiments. Recall that these constraints and validation formulas were entered when the attributes were defined for the various fields in the data structures that define the service and the service actions associated therewith when the service and service action(s) were created. In embodiments where the validation rules are stored in the service advisor itself, the validation rules are entered when the IT professional first defines the service advisor's decision tree. If the answer entered violates some constraint or validation rule, the dialog box soliciting the answer is redisplayed. In some embodiments, the redisplay of the dialog box of the service advisor will be modified to include a suggestion as to what is wrong with the dialog box.

In step 130, each answer entered by the user is stored in a different variable for use in navigating the decision tree.

In step 132, the next dialog box in the selected service advisor is looked up and displayed based upon conditional branching based upon the previous answer or based upon a pointer in a linked list in some embodiments.

In step 134, the system receives the answer entered by the user in response to the question displayed in the dialog of step 132, and validates the answer using validation rules stored in the service advisor, or, in the IT catalog attribute fields in some embodiments.

Step 136 represents the process of: branching to the appropriate dialog box based upon the preceding answer, displaying the dialog box, receiving user input answers to posed questions, validating answers, redisplaying dialog box (possibly with suggestion as to what was wrong) if the answer was invalid until a leaf on the decision tree is reached and a specific recommendation of a service action can be made. It is possible that more than one service action will be recommended to implement a requested service. Step 136 represents the process of continuing to ask questions, gather answers and branch to new questions appropriately until the decision tree has been completely traversed and all recommended service actions have been encountered. The recommendations of the service advisor will be based upon the answers the user gives, and if there are multiple options that will satisfy a user's requirements, as gleaned from his answers, then the recommendations will list the options and costs thereof. For example, if a user specifies that she need high reliability, then more costly multiple CPU architectures will be recommended. If there are multiple architectures that will suffice for this high reliability application, then all of them are listed and costs of each are given.

In step 138, all the service action recommendations encountered while traversing the decision tree are gathered and displayed. The system assumes that all service actions are to be carried out.

Step 140 represents the process of automatically filling in the elements of the service action(s) recommended. Specifically, the computer automatically fills in the fields of the data structures of all recommended service actions using the validated, stored responses of the user to the questions posed in the dialog boxes of the service advisor.

In step 142, the computer displays dialog boxes or otherwises solicits the user to enter data to fill in any still unpopulated fields in the data structure(s) of the recommended service action(s) that have not been previously filled in by step 140. This includes prompting the user to fill in relationship fields with pointers to other IT service actions or IT resources. The data the user enters is recorded in the appropriate unpopulated fields. In the preferred embodiment, the new data the user enters is validated using the validation rules previously stored by the IT professional in the attributes of the fields being filled in when the data structure was first created. This process may be as simple as checking the entered data against prevously stored minimums or maximums in the validation attributes of the field. Or it could be an evaluation of a formula previously entered by the IT professional and comparing the result to some validation constant previously entered by an IT professional or to the result of evaluation of another formula previously entered by an IT professional. Validated data is stored in the appropriate fields. Invalid data is rejected, and the user is prompted to enter new data. In some embodiments, the user is given a suggestion as to what is wrong with the original data the user entered.

The resulting filled in data structure(s) for the service actions constitute IT speak that the fulfillment process can understand and work with. If the user uses a service advisor, the user is able to enter data in response to service advisor questions posed in “customer speak”, i.e., simple terms that the average non IT professional customer understands.

Summarizing the configuration process in simple terms, it comprises the general steps of:
1) displaying an IT services catalog;
2) determining if a user that wishes to order an IT service selects an option for computer assistance in selecting a service action;
3) if a user requests assistance, displaying questions in an order dictated by a decision tree defined in advance by an IT professional, and traversing said decision tree based upon answers provided by the user via said computer input devices until one or more recommendations for service actions have been encountered;
4) gathering all recommended service actions and filling in fields in a data structure based upon answers given by said user;
5) upon completion of step 4, or if said user does not request assistance in step 2, soliciting said user to fill in all unpopulated fields of a data structure defining one or more service actions which are either selected by said user or which have been recommended by processing said decision tree and validating all user data input.
   In various species of this genus, step 3 includes validation of the answers provided to ensure they comply with constraints stored in attributes of a data field in the data structure of a recommended service action or constraints programmed into the service advisor.

The preferred embodiment of the configuration process comprises the steps:
displaying on a computer an IT services catalog which contains all the IT services that are available to order;
determining if a user who wishes to order an IT service knows the appropriate service action to select to create an instance of the desired IT service;
if the user does not know the appropriate service action to select, and picks a service advisor, launching a service advisor program in accordance with the user's selection;
looking up and displaying on said computer a first dialog box or other means of soliciting information from said user about the desired IT service by asking one or more questions;
receiving user responses to said one or more questions via said computer, and validating said responses, and using the answer(s) to vector processing to and displaying on said computer another dialog box or other means of soliciting information from said user about the desired IT service;
repeating the process of displaying questions and receiving responses and validating said responses and vectoring processing to the next question(s) based upon the response(s) to the previous question(s) until one or more recommendations for IT service actions are encountered in said decision tree;
gathering all recommendations of service actions encountered in traversing said decision tree in response to answers entered by said user;
using said computer to automatically fill in all fields of data structures defining one or more service actions recommended by said service advisor using information entered by said user in response to questions posed while traversing said decision tree;
using said computer to solicit said user to fill in any empty data fields of said one or more data structures defining one or more service actions recommended by said service advisor which were not filled in automatically by said computer and receiving information entered by said user and storing it in the appropriate fields of said one or more data structures; and
automatically filling in any unpopulated relationship fields.
   The Fulfillment Process

The fulfillment process is a process run by a computer which generates workflows to implement a service and get it approved by management. The workflows are sent to task queues of IT professionals who carry out the workflows step-by-step to implement a new instance of a service requested by an end user.

FIG. 8, comprised of FIGS. 8A and 8B, is a flowchart of the threshold approval process to obtain management approval to bring an instance of a service into existence followed by the fulfillment process to actually bring an instance of a service into existence. The process starts at block 150 and transitions to step 152. In step 152, the data structure(s) of the service action(s) that creates an instance of the desired service is/are accessed by the fulfillment process. These data structures have fields which are “IT speak”. That means that the contents of the data structure fields define all aspects of the service instance to be created and the approval and other workflows needed to get the instance of the service approved by management and to bring an instance of the service into existence.

The first order of business prior to actually carrying out the fulfillment process is to find and enforce the approval policy or policies defined in the approval workflow(s) to get the instance of the service to be created approved by management. The approval workflow is a recipe of steps that need to be followed to get the service instance to be created approved by management. More precisely, it is a recipe of steps that are defined in advance by an IT professional in accordance with the company approval policies to get an instance of whatever the service action is designed to create approved by management. There may be separate cost and computer architecture policies. The approval workflow is defined by the IT professional when the service action is first defined and is written in accordance with the company's cost and computer architecture policies.

There usually is a heirarchy of service actions that need to be performed to obtain approvals from management and, if approved, to bring an instance of a service into existence. The service actions in the heirarchy each have a data structure. Each data structure may point to an approval workflow and may also point to a fulfillment workflow. Each data structure of a service action which has a parent in the heirarchy will have a pointer to the parent service action. That parent service action may also have a parent (hereafter referred to as the grandparent service action), and the parent service action's data structure may contain a pointer to a fulfillment workflow and may contain a pointer to an approval workflow. The data structure of the parent service action will contain a pointer to the grandparent service action data structure. These pointers are defined by the IT professional at design time when the service action data structures are being created. The pointers are established so that the service actions are executed in the proper order to obtain approval and in the proper order to fulfill the request and bring an instance of the requested service into existence.

Both approval and fulfillment workflows are executed by the computer in the order of the heirarchy. This is done by loading into RAM and reading or just reading from disk the data structure of the service action that is lowest in the heirarchy (the child service action) at run time and executing any approval workflow to which the data structure of the service action points. After that approval workflow is executed, the computer determines if the child service action has a parent and, if so, follows a pointer to the data structure of the parent service action. If the parent service action has a pointer to an approval workflow, then that approval workflow will be loaded and executed. That approval workflow may have been defined by the IT professional to aggregate the costs of any service actions lower in the heirarchy (that depends upon the approval policies of the company or government or other entity in which the system is deployed). This process of executing approval workflows and then following pointers to the parent service actions and following pointers to their approval workflows and parent service actions continues until the highest service action in the heirarchy has been encountered and any approval workflow pointed to by the data structure of the parent has been executed. The company's acquisition, approval and computer architecture policies are encoded in the approval workflows by the IT professional that defines the approval workflows.

The same process if followed to execute fulfillment workflows. The order in which service actions in the heirarchy must be executed is defined by the pointers in their data structures which are defined by the IT professional when the service action data structures are created at design time. These service actions then have the fulfillment workflows that their data structures point to executed in the order of the heirarchy from bottom to top in just the same manner as described above for execution of the approval workflows.

Suppose, for example, that the service to be brought into existence is the installation of an e-mail server. To bring that service into existence, several steps need to be performed.

First, a server computer with sufficient capacity for the e-mail server needs to be acquired or allocated from servers already owned or leased by a company. This step needs to be done first because the software for email service cannot be installed until the server is obtained. This step to obtain the server will have its own service action and there will be some cost defined in the data structure of the service action to implement this step. This service action may also point to an approval workflow which defines an approval process according to approval policies encoded in an approval workflow such as, “send an email to IT professional Mr. Ashani that if the cost of the server to buy or lease is less than $5000 per year, just buy it or lease it, and report the cost to me your trusted computer, but if the cost to acquire or lease the server is more than $5000 per year, then send an email regarding the cost to Mr. Dueseldorf and seek his approval, and report back to me”. The fulfillment workflow will just be a simple, “send an email to Mr. Ashani and tell him to acquire by purchase, lease or allocation of capacity from servers already available in inventory a server having the following capabilities . . . and report back to me the time to accomplish this step, the cost to accomplish it, and whether the step was completed.” The fulfillment workflow will not be executed by the computer until the approval workflows have been executed and approvals obtained.

Next, the e-mail server software needs to be acquired, licensed or allocated from software inventory the company already owns or for which it has licenses and installed on the server. Obviously, no software can be installed until the server is acquired. Thus, the IT professional will define a pointer in the data structure of the service action to obtain the server to point to the service action to obtain the sofware so that the service action to acquire the software is performed after the service action to acquire the server. The activities to obtain the software will have either one or two service actions (acquire/license/allocate and then install) which define the costs for each step in their data structures.

The service action(s) for this acquire and install the software step will have data structures which may point to approval and fulfillment workflows. The approval workflow may be as simple as, “send an email to IT professional Mr. Ashani that if the cost of the software to add email capability to buy or lease is less than $2000 per year, just buy it or lease it, and report the cost to me your trusted computer, but if the cost to acquire or lease the server is more than $2000 per year, then send an email regarding the cost to Mr. Miller and seek his approval, and report back to me”. The fulfillment workflow will just be a simple, “send an email to Mr. Ashani and tell him to acquire by purchase, lease or allocation of capacity from email server software already available in inventory email server software having the following capabilities . . . and report back to me the time to accomplish this step, the cost to accomplish it, and whether the step was completed” The fulfillment workflow will not be executed by the computer until the approval workflows have been executed and approvals obtained.

Finally, the server needs to be installed on a suitable network such as one which has a gateway to the internet. This step will have a service action which defines the anticipated cost of this step (as did the service action data structures of the previous two steps), and the IT professional will set up pointers from the acquire a server and acquire the software service actions to point to this install the server service action. The approval workflow might be as simple as, “send an email to Mr. Ashani asking him to determine how many servers are on Network X and whether there are suitable firewalls, spam guard and other security installed on Network X, and report the proposed new configuration of Network X to the computer architectural approval committee, and aggregate the costs of the acquisition of the server and software and seek approval of Mr. Big if it is more than $15,000, and report back to me whether he approves the project or not.” The fulfillment workflow might be as simple as, “send an email to Mr. Ashani asking him to install the server on network X, and report the time and cost to do this back to me and report whether you finished the step.”

Step 152 represents the process of the computer “running” the approval workflow(s) of the pertinent service action(s) needed to get approval(s) for the service to be brought into existence. “Running” the approval workflows means enforcing the approval policies for costs and/or computer architectural constraints by carrying out the defined steps in the approval workflow(s) in the order they appear in the heirarchy. The actual enforcement of the polices are embodied into the pre-recorded steps of the approval workflow(s) defined by the IT professional who wrote the approval workflows in accordance with the cost and/or architecture policies. What the approval policies are depends upon the wealth and management style of the company. For example, the cost approval policy might be that no separate approval is needed for any service costing less than $5000. Another policy might be to aggregate all costs of all steps needed to bring a service into existence, and seek a single approval for the aggregate cost. Another policy might be to seek approval for the cost of each separate step except if the cost of any particular step is less than $5000. In such a case, separate approval only of steps costing more than $5000 need be sought.

Suppose the policy encoded in the approval workflows for the new e-mail service example is that only one approval is needed for the aggregate cost of all steps necessary to bring the service into existence. In such a case, step 152 represents: (1) accessing the data structures of the three service actions to carry out the three steps discussed above (obtain the server computer, obtain and install the e-mail software on the server, and install the server on the appropriate network); (2) looking up the approval workflows in each; and, (3) carrying out the steps defined in those approval workflows thereby enforcing the policies encoded therein. This might entail in a policy of aggregating costs and seeking one approval adding up the costs of all three steps and then performing the approval workflow of the highest service action in the heirarchy of service actions (called the “eve” service action). In such a case, the computer would follow a pointer in the data structure of the lowest service action in the heirarchy to the parent service action and then follow a pointer in that service action's data structure to its parent. This process would be continued until the “eve” service action was found. Then the computer follows a pointer from the eve service action data structure to the approval workflow of the eve service action.

Next, the computer must carry out the approval workflow, as symbolized by blocks 154 and 156. The first step in that process is following the pointer in the data structure of the service action to the location in memory where the data structure of the approval workflow is stored. Then, the data structure of the approval workflow is loaded into the computer's random access memory, as symbolized by step 154. Step 156 represents the process of the computer carrying out the steps of the approval workflow. In the example, the computer carries out the approval workflow steps to develop the aggregated cost and then seeks a single approval based upon the aggregated cost. If another policy such as no approval is needed for any service costing less than $500,000 (such as might be the case for Microsoft), if the aggregated cost was less than $500,000, then the computer would automatically approve implementation of the service and so code the data structure to indicate the approval.

All workflows including both fulfillment and approval workflows have only five different types of steps. Each different type of step has a set of computer program instructions to execute it. To execute that step in the workflow, the computer follows a pointer in the workflow data structure to the location in memory where the first instruction in the set of instructions is stored. The instructions are then executed. Each workflow is like a linked list in that the code for each step is executed using the data in the data structure if there are variables or other input that are needed. Then a pointer to the set of instructions for the next step is followed and those instructions are executed using the data in the data structure if there are variables or other input that are needed. The instructions in the various steps may control the computer to do anything required to accomplish the end result such as print out the estimated cost or e-mail the estimated cost to a particular IT professional with instructions to submit that cost to a particular executive for approval. Manual steps that the computer cannot itself accomplish are accomplished by sending a task and its details to a particular user's task queue. The user then executes the described task and reports back to the computer by inputting the time it took to do the task and reporting whether or not the task was finished. The computer then records the data entered by the IT professional who carried out the task and then goes to the next step in the process of the workflow.

Returning to the consideration of approval workflows in particular, if, for example, the policy encoded in the instructions of an approval workflow is that two approvals are needed for a particular level of cost, the instructions executed by the computer control the computer to send an e-mail containing the cost to implement the desired service to a particular IT professional with instructions to seek a first level of approval from a particular executive. The e-mail would further instruct the IT professional carrying out this step, that if the first level executive approves the desired service, the IT professional is to then seek final approval from another executive and to report back the status of the approvals.

Step 158 represents a determination by the computer whether the creation of the service instance has been approved. The computer instructions will instruct the IT professional to report back and enter data on whether the service instance has or has not been approved. Step 158 checks for data entered by the IT professional indicating whether all necessary approvals have been obtained. If not, it is possible another approval workflow in the heirarchy of approval workflows needs to be executed. Processing then vectors to step 160 which finds the next approval workflow in the heirarchy by following pointers in the service action data structures of the heirarchy. Once the next approval workflow is found, it is loaded into memory, and processing proceeds back to step 152 to execute the new approval workflow currently loaded in memory.

If all necessary approvals have been obtained, the fulfillment process is started, as represented by block 162. The fulfillment process simply entails the computer finding the right fulfillment workflow (step 164) and executing the steps therein (steps 166, 168), and recording feedback information entered by the IT professional who carried out any manual steps. The appropriate IT professional to accomplish each manual step will be designated in the fulfillment workflow. That information as to the appropriate IT professional or skill set needed was added at design time by the professional who wrote the fulfillment workflow. The IT professional who designates the particular IT professional or group of IT professionals or the skill set needed to accomplish any particular task will make the designations based upon the skills needed to accomplish the task. At design time, the IT professional may also designate that the computer determine availability of an IT professional having the requisite skills at fulfillment time, and this is usually done when the IT service request specifies a scheduled completion date by which the project must be done. The computer routes the requests to perform manual tasks when there is an availability check by first checking a record of hours of work projected for each IT professional in a group having the requisite skill set and then routes the request to the most available IT professional in the group.

In the preferred embodiment, when the computer executing the fulfillment workflow checks the availability of an IT professional to perform the task, it also determines the resources that will be required to perform the task, and checks inventory to make sure those resources are available.

Any statements in the fulfillment workflow which designate the type and how much of the physical and logical resources in inventory that will be consumed by each step are added to the bill of materials.

Finding the appropriate fulfillment workflow is the first order of business, and is represented by step 164. If the service action whose data structure was loaded in step 152 is a new service action with no relationship to any parent service action, the data structure of the service action will have a pointer therein to the data structure of a fulfillment workflow which, when executed, brings an instance of the requested service into existence. If the service action whose data structure was loaded in step 152 has a relationship to a parent service action, the data structure loaded in step 152 will have a pointer to another parent service action and may also have a pointer to a fulfillment workflow. The computer will then follow the pointer to the fulfillment workflow pointed to by the lowest service action, load the fulfillment workflow into RAM and execute it by following pointers to the computer instructions that implement each step in the workflow. After completing this first fulfillment workflow, the computer will then traverse the pointer in the child service action data structure to the data structure of the parent service action and look for a pointer therein to a fulfillment workflow. If there is one, the computer will then execute that fulfillment workflow by traversing the pointer to the fulfillment workflow data structure, loading it into memory (step 166) and executing it (step 168). If the parent service action data structure has no pointer to a fulfillment service action, or the fulfillment workflow of the parent service action has been completed, the computer looks for a pointer to a grandparent service action. If the computer finds a pointer to a grandparent service action, it follows that pointer to the data structure of the grandparent service action and searches the data structure for a pointer to a fulfillment workflow. That fulfillment workflow is then loaded into memory and executed. This process is continued to traverse the heirarchy in an upward direction until the “eve” service action is found (the highest service action in the heirarchy) and any pointer to a fulfillment workflow data structure for the eve service action has been found. That fulfillment workflow for the eve service action is then loaded into memory in step 166 and executed.

Steps 166 and 168 represent this process of loading and executing all the fulfillment service actions in the heirarchy. More precisely, step 168 represents the process of executing the fulfillment workflow by following pointers therein to a set of instructions corresponding to each step in the workflow. The instructions corresponding to each step control the computer to carry out whatever functions are necessary to accomplish the step in the workflow. If the step is something the computer can do itself, it does so, and if any data is needed to accomplish the step, that data will be loaded from the data structure field(s) corresponding to the step in the fulfillment workflow being accomplished. If the step can only be accomplished by a human, the instructions will control the computer to send a task and its details to a particular individual's task queue with instructions to accomplish the task and report back to the computer the time it took to perform the task and whether the task was accomplished. The individual then carries out the task, and reports back the time and cost it took him to carry it out and whether it was finished or not. This information is then recorded in step 170.

The computer which runs the fulfillment process keeps track of the state of progress in executing the fulfillment workflow. The fulfillment workflow is like a state diagram. There is a transition from one state to another each time a step in the fulfillment workflow is finished. The computer keeps track of which automatic steps in each fulfillment workflow that the computer itself has accomplished, and it keep track of which manual steps have been accomplished by IT professionals using the feedback data entered by the professional after performing a manual task regardless of whether the task has been completed or not. The same holds true of the approval workflows. The computer can therefore report the status of completion of either an approval process or a fulfillment process at all times.

In step 171, an optional service lifecycle report is generated from the stored cost and time to complete data of each step of the fulfillment workflow. In some embodiments, this is done for every workflow in the heirarchy, but in other embodiments, only a single report for all the fulfillment workflows in the heirarchy is generated. The service lifecycle report contains the results of comparison between the projected cost and schedule for each step in a fulfillment workflow, as recorded in the data structures, and the actual cost and time to complete entered as feedback data. The results of this comparison are stored, and can be used later for off-line generation of reports called service lifecycles.

Service actions are frequently arranged in heirarchical fashion, and creation, modification or deletion of a service is accomplished as a series of fulfilment workflows, each associated with one of the service actions in the heirarchy. After step 171 is accomplished, it is desirable to determine whether the fulfillment workflow just completed is the last one in the chain that needs to be completed. Step 173 determines if the fulfillment workflow just completed is the last one in the heirarchy by looking for pointers to a parent service action in the data structure of the service action whose fulfillment workflow was just completed. If there are no pointers to a parent, then processing proceeds to step 172 and the fulfillment process is done. If there is a pointer to a parent service action, that pointer is followed to the data structure of the parent service action and a pointer in the parent service action data structure to the fulfillment workflow of the parent service action is followed in step 175. Processing then proceeds to step 166 to load that fulfillment workflow into memory and the processing to execute the new fulfillment workflow is repeated.

Although the invention has been disclosed in terms of the preferred and alternative embodiments disclosed herein, those skilled in the art will appreciate possible alternative embodiments and other modifications to the teachings disclosed herein which do not depart from the spirit and scope of the invention. For example, the fulfillment process may be practiced without first executing approval workflows either because the approval process is all manual or because no approval process exists at all in, for example, small companies or governments who do not care how much they spend. All such alternative embodiments and other modifications are intended to be included within the scope of the claims appended hereto.

1. A process executed on a computer for defining services listed in an IT services catalog, comprising the steps:
(1) displaying a plurality of icons or menu choices which can be selected to start the process of creating a new service, or modifying a preexisting service and/or resource, or define cost information or define a service action;
(2) if an icon or menu choice is selected to start the process of creating a new service, displaying one or more displays soliciting information from a user to name the service and define the fields and contents thereof for a data structure which defines an instance of said service and define attributes of each field including validation constraints and validation formulas, and receiving and storing any data entered by a user in response to said displays;
(3) if an icon or menu choice is selected to start the process of defining a relationship, displaying one or more displays soliciting information as to which preexisting service or IT resource to which the data structure of a service will point and receiving and storing any data entered by a user in response to said displays so as to allow a hierarchy of services to be defined by entry of said pointers;
(4) if an icon or menu choice is selected indicating a user wishes to enter cost information, displaying one or more displays which solicit the user to enter information that define the name of a cost information formula and the cost information formula itself, and receiving and storing any data entered by a user in response to said displays; and
(5) if an icon or menu choice is selected indicating a user wishes to define a service action, displaying one or more displays that solicit the name of the service action to be defined and to define the fields and contents thereof for a data structure which defines an instance of said service action and attributes for each field, and receiving and storing any data entered by a user in response to said displays, said one or more displays also allowing a user to enter pointer data which defines relationships between service actions in a hierarchy of service actions to create, modify or destroy instances of services.

2. The process of claim 1 wherein the process of creating each field in a data structure allows text, numbers of formulas to be stored in the field as if the field were a spreadsheet cell, and further comprising the steps of determining if a user is a high level or low level user and, if a high level user has logged in who needs the assistance of building blocks or primitives, displaying a palette of building blocks which the user can use to define services or service actions or relationships therebetween, and receiving user input regarding which building blocks the user wishes to combine and how the user wishes to combine them, and then using the data in the data structures of the building blocks to populate the fields of the data structure of the service or service action the user is attempting to define.

3. The process of claim 1 wherein the process of creating each field of a data structure allows attributes to be defined for each field which define whether the field is configurable, whether the data of a field can be overriden by new data entered by a user, and which define constraints for the field in the form of formulas that define maximum and/or minimum limits for a field or which define a property which must be true about the content of said field.

4. The process of claim 2 wherein the process of creating each field of a data structure allows attributes to be defined for each field which define whether the field is configurable, whether the data of a field can be overriden by new data entered by a user, and which define constraints for the field in the form of formulas that define maximum and/or minimum limits for a field or which define a property which must be true about the content of said field.

5. The process of claim 1 wherein step 2 further comprises the steps of:
displaying one or more displays which solicit the user to enter data defining:
a database model which defines the information stored in a data structure that defines an instance of said service;
one or more relationship fields each of which contains a pointer to another IT service and/or resource which said IT service is an extension of or which will be utilized in said IT service;
one or more cost information fields each of which which records formulas that are used to compute the cost of implementing or using said service;
one or more service action fields, each of which contains a pointer to a data structure which defines an instance of a service action, each service action defining an action that can be taken when a service is used such as create, modify or delete.

6. The process of claim 5 wherein step 5 of creating one or more service action data structures comprises the steps of:
defining one or more models that define the information that is stored in a database or data structure which define an instantiation of said service action;
defining one or more relationship fields which contain pointers to other service actions or resources so as to define a heirarchy of service actions if any;
defining one or more fields which contain formulas for computing the cost to perform said service action one time;
defining one or more fields that contain schedule information or a formula to compute an approximate time to complete a service action and/or how soon said service action can start;
defining a field that contains a pointer to a fulfillment workflow data structure and defining said fulfillment workflow structure in the form of a specification of the steps that need to be performed to accomplish said service action and the order, if any, in which the steps need to be performed;
defining one or more fields that contain validation logic in the form of constraints on the values of one or more fields and/or validation formulas to determine whether a value in a field satisfies a constraint; and
defining one or more fields that contain an approval workflow in the form of a specification of the steps that need to be performed to accomplish approval by management to carry out said service action.

7. The apparatus of claim 6 wherein said step of defining said data structure of said fulfillment workflow includes the steps of defining the physical and/or logical resources which will be required to accomplish each step in said workflow.

8. The apparatus of claim 6 wherein said step of defining said data structure of said fulfillment workflow includes the steps of defining the particular IT professional or the skill set needed by an IT professional to accomplish each manual task in said fulfillment workflow.

9. A computer programmed to carry out the following steps:
(1) displaying a plurality of icons or menu choices which can be selected to start the process of creating a new service, establishing a relationship between a new service and a preexisting service and/or resource, define cost information or define a service action;
(2) if an icon or menu choice is selected to start the process of creating a new service, displaying one or more displays soliciting information from a user to name the service and define the fields and contents thereof for a data structure which defines an instance of said service and define attributes of each field including validation constraints and validation formulas, and receiving and storing any data entered by a user in response to said displays;
(3) if an icon or menu choice is selected to start the process of defining a relationship, displaying one or more displays soliciting information as to which preexisting service or IT resource to which the data structure of a service will point and receiving and storing any data entered by a user in response to said displays;
(4) if an icon or menu choice is selected indicating a user wishes to enter cost information, displaying one or more displays which solicit the user to enter information that define the name of a cost information formula and the cost information formula itself, and receiving and storing any data entered by a user in response to said displays; and
(5) if an icon or menu choice is selected indicating a user wishes to define a service action, displaying one or more displays that solicit the name of the service action to be defined and to define the fields and contents thereof for a data structure which defines an instance of said service action and attributes for each field, and receiving and storing any data entered by a user in response to said displays.

10. The computer of claim 9 further programmed to carry out the following steps when carrying out step 2:
displaying one or more displays which solicit the user to enter data defining:
a database model which defines the information stored in a data structure that defines an instance of said service;
one or more relationship fields each of which contains a pointer to another IT service and/or resource which said IT service is an extension of or which will be utilized in said IT service;
one or more cost information fields each of which which records formulas that are used to compute the cost of implementing or using said service;
one or more service action fields, each of which contains a pointer to a data structure which defines an instance of a service action, each service action defining an action that can be taken when a service is used such as create, modify or delete.

11. The computer of claim 10 further programmed to carry out the following steps when carrying out step 5 to define a service action:
defining one or more models that define the information that is stored in a database or data structure which define an instantiation of said service action;
defining one or more relationship fields which contain pointers to other service actions or resources;
defining one or more fields which contain formulas for computing the cost to perform said service action one time;
defining one or more fields that contain schedule information or a formula to compute an approximate time to complete a service action and/or how soon said service action can start;
defining a field that contains a fulfillment workflow in the form of a specification of the steps that need to be performed to accomplish said service action and the order, if any, in which the steps need to be performed;
defining one or more fields that contain validation logic in the form of constraints on the values of one or more fields and/or validation formulas to determine whether a value in a field satisfies a constraint; and
defining one or more fields that contain an approval workflow in the form of a specification of the steps that need to be performed to accomplish approval by management to carry out said service action.

12. A computer readable medium having computer-executable instructions for performing a method comprising:
(1) displaying a plurality of icons or menu choices which can be selected to start the process of creating a new service, establishing a relationship between a new service and a preexisting service and/or resource, define cost information or define a service action;
(2) if an icon or menu choice is selected to start the process of creating a new service, displaying one or more displays soliciting information from a user to name the service and define the fields and contents thereof for a data structure which defines an instance of said service and define attributes of each field including validation constraints and validation formulas, and receiving and storing any data entered by a user in response to said displays;
(3) if an icon or menu choice is selected to start the process of defining a relationship, displaying one or more displays soliciting information as to which preexisting service or IT resource to which the data structure of a service will point and receiving and storing any data entered by a user in response to said displays;
(4) if an icon or menu choice is selected indicating a user wishes to enter cost information, displaying one or more displays which solicit the user to enter information that define the name of a cost information formula and the cost information formula itself, and receiving and storing any data entered by a user in response to said displays; and
(5) if an icon or menu choice is selected indicating a user wishes to define a service action, displaying one or more displays that solicit the name of the service action to be defined and to define the fields and contents thereof for a data structure which defines an instance of said service action and attributes for each field, and receiving and storing any data entered by a user in response to said displays.

13. The computer readable medium of claim 12 wherein said computer-executable instructions include instructions to perform the following steps when performing step 2 of the method:
displaying one or more displays which solicit the user to enter data defining:
a database model which defines the information stored in a data structure that defines an instance of said service;
one or more relationship fields each of which contains a pointer to another IT service and/or resource which said IT service is an extension of or which will be utilized in said IT service;
one or more cost information fields each of which which records formulas that are used to compute the cost of implementing or using said service;
one or more service action fields, each of which contains a pointer to a data structure which defines an instance of a service action, each service action defining an action that can be taken when a service is used such as create, modify or delete.

14. The computer readable medium of claim 13 wherein said computer-executable instructions include instructions to perform the following steps when performing step 5 of the method:
defining one or more models that define the information that is stored in a database or data structure which define an instantiation of said service action;
defining one or more relationship fields which contain pointers to other service actions or resources;
defining one or more fields which contain formulas for computing the cost to perform said service action one time;
defining one or more fields that contain schedule information or a formula to compute an approximate time to complete a service action and/or how soon said service action can start;
defining a field that contains a fulfillment workflow in the form of a specification of the steps that need to be performed to accomplish said service action and the order, if any, in which the steps need to be performed;
defining one or more fields that contain validation logic in the form of constraints on the values of one or more fields and/or validation formulas to determine whether a value in a field satisfies a constraint; and
defining one or more fields that contain an approval workflow in the form of a specification of the steps that need to be performed to accomplish approval by management to carry out said service action.
